(19) United States
(12) Patent Application Publication
(10) Pub. No.: US 2011/0094436 A1
(43) Pub. Date: Apr. 28, 2011

(54) Vertical flag display apparatus

(76) Inventor: Pamela Fivgas, Arvada, CO (US)

(21) Appl. No.: 12/925,710

(22) Filed: Oct. 28, 2010

Related U.S. Application Data
(60) Provisional application No. 61/279,943, filed on Oct. 28, 2009.

(51) Int. Cl. G09F 17/00

(52) U.S. Cl. 116/173

(57) ABSTRACT

A vertical flag display apparatus comprises a support bar, a flag spar, a flag pole, and locking end caps. The flag spar can be a rod, bar, or other tubular pole. The flag spar threads through a flag sleeve so that the flag hangs down from the spar when the spar is held parallel to the ground. The locking end caps attach to an end of the spar and ensure that the flag can not slide off of the spar. The end caps attach to each end of the support bar securing the spar to the support bar. The flag pole attaches to the support bar and extends downwards and perpendicular to the support bar. The flag pole is attached to the side of a building, etc. so as to hold the flag pole generally 45 degrees out from the side of the building and in an upwards orientation.

### CROSS-REFERENCE TO RELATED APPLICATIONS

This application claims the benefit of U.S. Provisional Application No. 61/279,943 entitled “Improved Apparatus for Displaying a Flag Vertically” and filed on Oct. 28, 2009.

### TECHNICAL FIELD

The invention relates generally to flags and flag display devices and more particularly to a vertical flag display apparatus for displaying a flag in a vertical orientation generally parallel to a wall or other location.

### BACKGROUND

There are many methods for hanging and/or displaying a flag currently known. The classic flag pole relies on a generally vertical pole fixed to the ground or other location with a flag attached to a rope apparatus that can be used to raise the flag from the ground to the top of the pole. Generally speaking, flags are rectangular in shape, having two short sides and two long sides defining the perimeter of the flag. Usually, one of the short sides is attached to the rope apparatus. Thus, when the wind blows, it causes the flag to extend outwards, such that the long sides of the flag extend parallel to the ground. The flag is then displayed for all to see. However, when the wind is not blowing, a standard flag display apparatus allows the flag to hang limply from the rope apparatus. Most of the flag is then folded over itself, causing the entire field of the flag not to be viewable.

Flags are basically two dimensional in appearance, comprising a sheet of fabric or other material(s) having a front face and a rear face, both faces surrounded by a rectangular perimeter having two opposite and parallel short sides and two opposite and parallel long sides. The faces display the field of the flag; usually the same field is displayed on both faces of the flag. The field can depict a design, a motto, an emblem, a picture, a phrase, one or more colors, combinations of the aforementioned items, etc. For example, the United States flag has a blue rectangle covered in 50 white stars in the upper left of the field and the remainder of the field has alternating red and white stripes. When a US flag is displayed from a standard flag pole and the wind is not blowing, the configuration of the items displayed in the field can be difficult to discern.

In order to overcome this deficiency in standard flag display devices, other types of devices have begun to grow in popularity. One class of devices holds rectangular flags in a rigid manner so that they extend out from a flagpole or other structure regardless of whether a wind is blowing or not. However, such devices give the flag a stiff, unappealing appearance and are not favored. Instead, many persons display flags in a vertical orientation where the long sides of the flag hang downwards and are perpendicular to the ground. Vertical flag display devices that can display a flag in this manner are varied; but generally, they have a spar or horizontal member which holds one of the short ends of the flag and allows the flag to hang vertically. A problem inherent in most such vertical display devices lies in the attachment of the flag to the spar. Nails, tacks, etc. are often employed which can damage the flag, especially with repeated use.

U.S. Pat. No. 6,402,116 to Northup attempts to overcome the above mentioned deficiency by employing a flag having a channel through which the spar (or dowel) is slid. The flag and spar are then inserted into a sleeve having a slit through which the flag can extend downwards. The sleeve has a threaded opening in its sidewall that accepts a threaded support pole. When the pole is screwed into the opening it places pressure on the flag and dowel, securing the flag to the dowel without puncturing the flag. However, this arrangement has a number of deficiencies itself. First, the end of the support pole that is pushing against the flag wears on the flag each time it is affixed to the sleeve, causing a wear spot to develop on the flag. Such a spot can eventually become a hole in the flag—exactly the problem that the Northup device was designed to avoid. Furthermore, in heavy winds, the dowel, flag and sleeve can be rotated by the wind relative to the support pole, causing the device to separate and the flag to be lost as the support pole no longer puts pressure on the flag. Finally, the Northup device also has no provision for securing the corners of the flag on the ends of the dowel such that a high wind can cause the loose corners to be pushed towards the support pole and the flag then ‘bunches-up’ making it difficult for an observer to see the entire field.

What is needed is a flag display apparatus that can hold a flag in a vertical orientation without damaging the flag and without the possibility of losing the flag in high winds.

### SUMMARY

One embodiment of the present invention is a device comprising a support bar, a flag spar, a flag pole, locking end caps, securing clips, and an attachment bracket. A vertical flag display apparatus can display various types of flags without damaging them. If the flag to be displayed has a sleeve on one of its edges, the apparatus can use a standard flag spar. The flag spar can be a rod, bar, or other tubular pole that is approximately as long as the sleeve of the flag. In other embodiments, the flag spar is longer or shorter than the length of the sleeve. The flag spar can be threaded through the sleeve so that the flag hangs down from the spar when the spar is held parallel to the ground. Each of the locking end caps then attach to an end of the spar in order to ensure that the flag can not slide off the spar. Securing clips can be placed on each end of the spar and function to hold the flag corners in place under high-wind conditions. The end caps then attach to each end of the support bar securing the spar to the support bar. The support bar extends generally parallel to and above the spar in one embodiment. The flag pole attaches to approximately the center of the support bar and extends generally 45 degrees downwards and perpendicular to the support bar. The flag pole is then placed in the attachment bracket and the bracket is attached to the side of a building or other location so as to hold the flag pole generally 45 degrees out from the side of the building and in an upwards orientation. Other angles besides 45 degrees are contemplated. The described device holds the flag in a vertical orientation so that it is parallel with the side of the building. However, as the flag is only in contact with the device along the length of the flag spar, the remainder of the flag is free to flutter and move with the wind.

If the flag to be displayed does not have a sleeve, the flag spar can be configured to securely hold an edge of a standard flag. Various mechanisms are contemplated including a clamp bar that holds the entire length of the flag to the spar. In another embodiment, the spar contains a channel in which the edge of a flag can be inserted and then the spar closes tightly on the flag ensuring that it is secured therein.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a perspective view of a vertical flag display apparatus in accordance with an aspect of the present invention;

FIG. 2 illustrates a close-up side view of a vertical flag display apparatus;

FIG. 3 illustrates a close-up front elevation view of a locking end cap component of a vertical flag display apparatus;

FIG. 4 illustrates a close-up side elevation view of a locking end cap component;

FIG. 5 illustrates a close-up side elevation view of a locking end cap and a locking clip;

FIG. 6 illustrates a close-up front elevation view of a locking clip.

### DETAILED DESCRIPTION

In the following discussion, numerous specific details are set forth to provide a thorough understanding of the present invention. However, those skilled in the art will appreciate that the present invention may be practiced without such specific details.

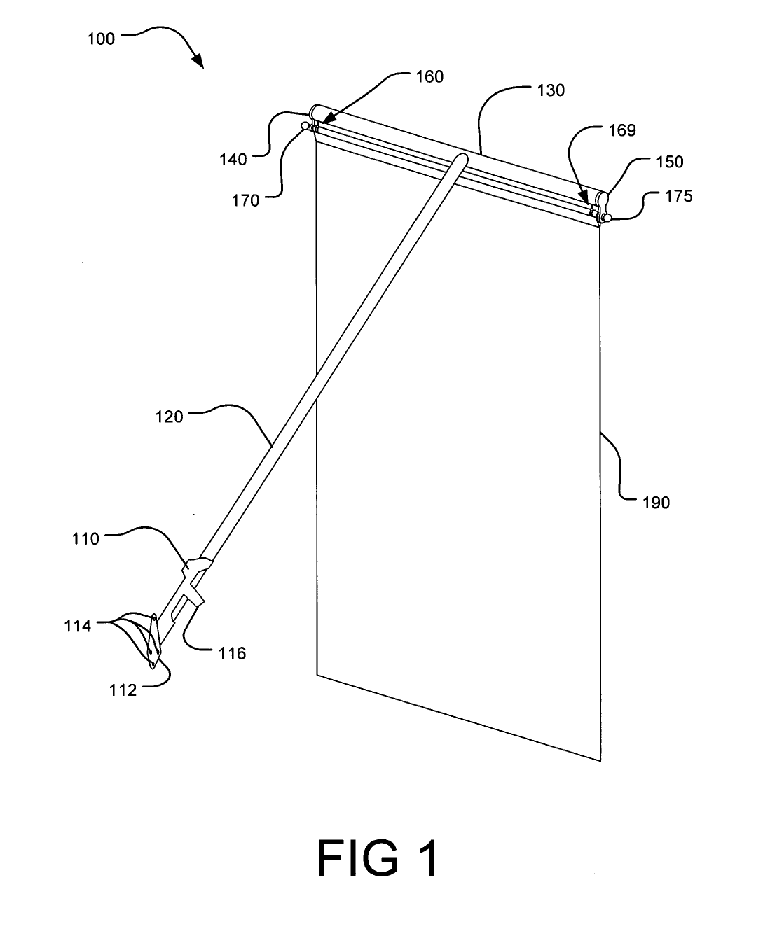

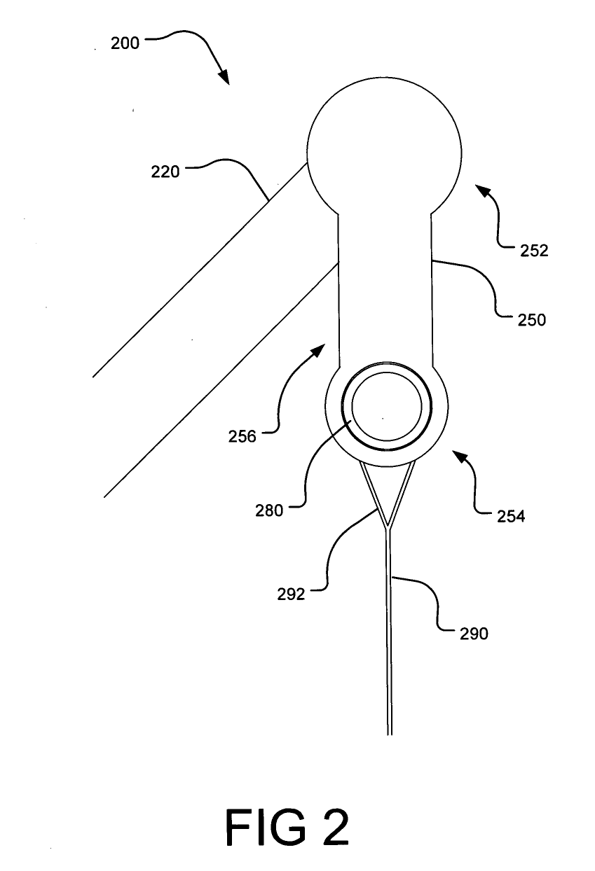

Referring now to the drawings, FIG. 1 illustrates a perspective view of a vertical flag display apparatus 100 in accordance with an aspect of the present invention. The embodiment shown in FIG. 1 has the following displayed components: an attachment bracket 110, a pole 120, a support bar 130, a first locking end cap 140, a second locking end cap 150, a first locking clip 160, a second locking clip 169, a first accent cap 170, and a second accent cap 175. Also shown is an exemplary flag 190. A flag spar is used to support the flag 190, but the spar 280 is not visible in FIG. 1, see FIG. 2, item 280.

The attachment bracket 110 illustrated in FIG. 1 is shaped with a generally flat attachment plate 112 having mounting holes 114 that accept fasteners to attach the bracket 110 to a wall or other attachment point. In other embodiments, other means of attaching the attachment bracket 110 to an attachment point are contemplated. Furthermore, the attachment bracket 110 does not have to have a generally flat attachment plate 112, instead, it can be shaped to generally match the surface of the attachment point. The attachment bracket 110 is illustrated in FIG. 1 as having a second angled receptacle 116 for receiving the pole 120 at a second angle. Other embodiments can have only one receptacle or a plurality thereof.

The pole 120 has a proximal end that rests in the receptacle of the bracket 110. The distal end of the pole 120 attaches to the support bar 130. As illustrated in FIG. 1, the pole can be generally straight in shape; other shapes of poles 120 are known in the art and can be utilized herewith. The function of the pole 120 is to extend the position of the flag 190 out away from the attachment point. The pole 120 shown in FIG. 1 has a cross-section that is generally shaped as a circle, other shapes are contemplated.

The pole 120 is connected to the support bar 130. As shown in FIG. 2, the distal end of the pole 120 contacts the support bar 130. The attachment can be permanent or it can be removably affixed. As shown in FIG. 2, the distal end of the pole can be shaped so as to closely match the curved surface of the support bar 130. A simple removable connection means such as a screw can be used to affix the support bar 130 to the pole 120. Other attachment means are contemplated.

The support bar 130 is shown in FIG. 1 as being generally cylindrical in shape. However, in other embodiments, the support bar 130 can be other shapes. The support bar 130 functions as an intermediary support structure between the flag spar (see item 280 in FIG. 2) and the pole 120.

At each end of the support bar 130 is a locking end cap 140 and 150. The end caps are designed to lock securely to the support bar 130 and receive and hold the flag spar 280. See the descriptions of FIGS. 2-5 for further explanations of the locking end caps 140 and 150.

In order to mount a flag on the vertical flag display apparatus 100, the flag spar 280 is removed from at least one of the locking end caps 140 and 150 and the flag 190 is attached thereto. In the embodiment shown in FIG. 1, the flag 190 has a sleeve which slides over the flag spar 280. In other embodiments, the flag spar 280 can have a channel for receiving an end of the flag 190 and then can be tightened so as to secure the flag 190 to the flag spar 280—such embodiments allow flags that do not have a sleeve to be flown by the apparatus 100.

Once the flag 190 is affixed to the flag spar 280, the spar 280 is reattached to the locking end caps 140 and 150. In one embodiment, first and second locking clips 160 and 169 can then be secured over the flag 190 to ensure that the flag 190 stays in place on the flag spar 280 even in high-wind conditions. In other embodiments, other means of securing the flag 190 to the spar 280 can be used. In yet another embodiment, no means of securing the flag 190 are used.

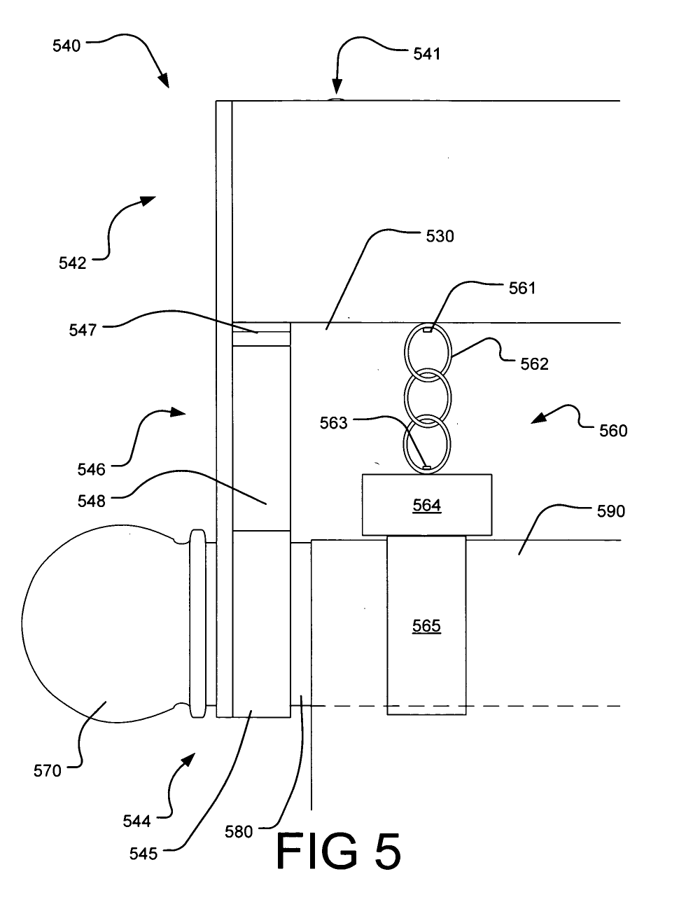

The first and second accent caps 170 and 175 attach at either end of the flag spar 280 outside of the first and second locking end caps 140 and 150 in order to secure the flag spar 280 to the end caps 140 and 150. For additional descriptions of the accent caps 170 and 175, see FIG. 5 and descriptions thereof below.

Once the flag 190 is properly secured to the vertical flag display apparatus 100, the pole 120 can be placed in the attachment bracket 110 and the flag 190 is then on display. As can be seen in FIG. 1, a flag 190 displayed using the apparatus 100 hangs vertically with both fields in full view, even if no wind is present to move the flag 190.

FIG. 2 illustrates a close-up side view of a vertical flag display apparatus 200. The distal end of a flag pole 220 can be seen as can the conforming shape of the attachment point thereof as it meets the support bar 130 (not shown in FIG. 2, see FIG. 1). Other shapes are contemplated as are other means of attaching the pole 220 to the support bar 130 (for a description of one possible means, see FIG. 1 description above).

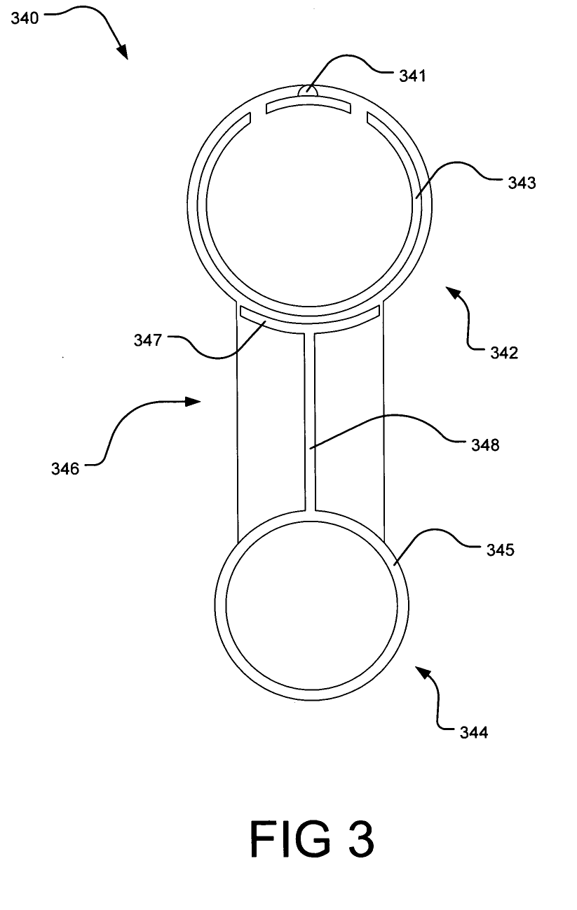

One locking end cap 250 is illustrated in FIG. 2. The locking end cap 250 has a support bar cap component 252, a flag spar cap component 254, and an extension component 256 connecting the first two components 252 and 254. The support bar cap component 252 connects the locking end cap 250 to one end of the support bar 130. For a detailed description of how one embodiment accomplishes this connection, see the description for FIG. 3 below. The flag spar cap component 254 connects the locking end cap 250 to one end of the flag spar 280.

As illustrated in FIG. 2, the flag spar 280 is cylindrically shaped and passes completely through the flag spar cap component 254 of the locking end cap 250. In order for the flag spar 280 to be visible, the accent cap 175 is not attached to the end of the flag spar 280. For descriptions thereof, see FIG. 5, item 570 (which is a mirror of item 175).

The extension component 256 functions to adequately space the support bar 130 from the flag spar 280. This is done for appearances and to allow the flag 290 to be supported by the spar 280 without contacting and rubbing on the support bar 130. Furthermore, the spacing allows room for the locking clips 160 and 169 to secure the flag 290 to the spar 280.

The flag 290 illustrated in FIG. 2 has a sleeve 292 that allows the flag spar 280 to be inserted therein. As noted above, the apparatus 200 can be used with a standard flag that does not have a sleeve.

FIG. 3 illustrates a close-up front elevation view of a locking end cap 340 of a vertical flag display apparatus. One locking end cap 340 is illustrated in FIG. 3. The locking end cap 340 has a support bar cap component 342, a flag spar cap component 344, and an extension component 346 connecting the first two components 342 and 344.

The support bar cap component 342 connects the locking end cap 340 to one end of the support bar 130. In one embodiment, this is accomplished by sliding the support bar flange 343 in one end of the support bar 130. The fit between these two components is such that the locking end cap 340 is tightly held within the support bar 130. Additionally a locking spring button flange 341 also can be utilized; it slides into the support bar 130 as well. The sliding action forces the flange 341 downwards and causes tension as the flange 341 can be made of a springy, resilient material. When the flange 341 is fully seated within the support bar 130, a spring button pops up into a hole in the support bar 130 releasing at least some of the tension on the flange 341 and thereby securing the locking end cap 340 to the support bar 130.

The flag spar cap component 344 connects the locking end cap 340 to one end of the flag spar 280. This is accomplished by inserting one end of the flag spar 280 through the flag spar flange 345. The fit between these components can be made tight enough that no further securing means is necessary. However, in one embodiment, an accent cap 170 having an outside diameter greater than the inside diameter of the flag spar flange 345 can be attached to the end of the flag spar 280 effectively stopping the flag spar 280 from sliding back through the flag spar flange 345. For a more detailed description of the accent cap 170 see FIG. 5 and its descriptions below.

The extension component 346 has two additional flanges as well. The first is a secondary support bar flange 347 that serves to further engage the support bar 130 and ensure that the locking end cap 340 is secured to the support bar 130. The second flange is the rigidity flange 348 which serves to provide strength and rigidity to the extension component 346. Other means of accomplishing these goals are contemplated.

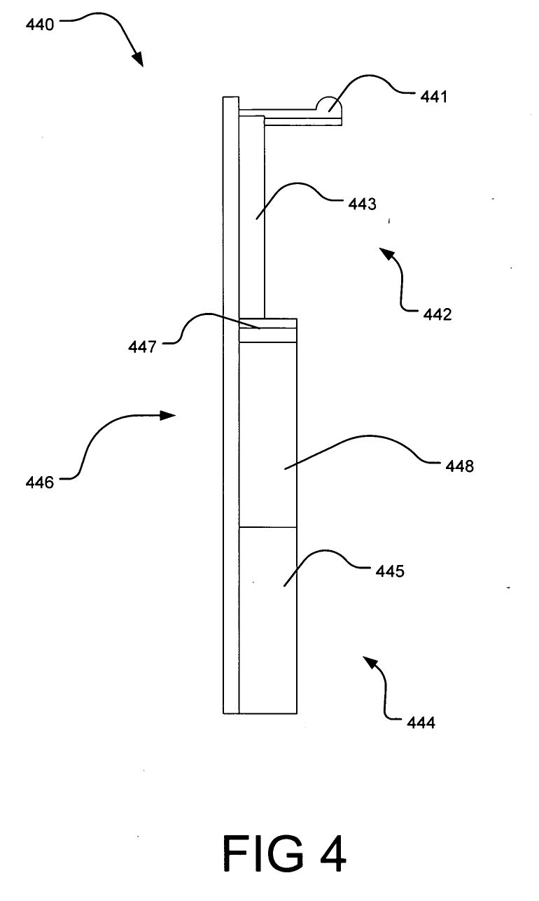

FIG. 4 illustrates a close-up side elevation view of a locking end cap 440. The support bar cap component 442, flag spar cap component 444, extension component 446, support bar flange 443, locking spring button flange 441, flag spar flange 445, secondary support bar flange 447, and rigidity flange 448 are shown from the side view (see FIG. 3 for an additional view of these components).

FIG. 5 illustrates a close-up side elevation view of a locking end cap 540 and a locking clip 560. The support bar cap component 542, flag spar cap component 544, extension component 546, locking spring button flange 541, flag spar flange 545, secondary support bar flange 547, and rigidity flange 548 are shown from the side view (see FIGS. 3 and 4 for additional views of these components).

Additionally, FIG. 5 illustrates the first accent cap 570. The cap 570 removably attaches to the flag spar 580 and locks the spar 580 to the locking end cap 540. The support bar 530 is locked to the support bar cap component 542 as well.

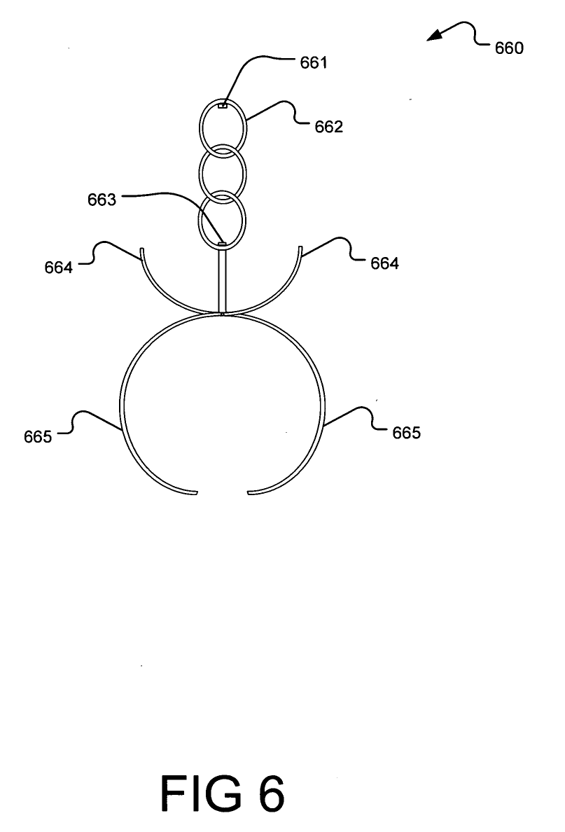

A first locking clip 560 is illustrated in FIG. 1. The clip 560 has a support bar attachment component 561 that can be any means of attaching the clip 560 to the support bar 530, in the embodiment shown here, it is a small bolt. A chain 562 attaches the support bar attachment component 561 to the clip attachment component 563 (here, another small bolt). In other embodiments, other means of attaching the clip components to the support bar 530 are contemplated. The clip handles 564 and the clip body 565 are shown in FIG. 5, for a description of their functionality, see FIG. 6 below.

FIG. 6 illustrates a close-up front elevation view of a locking clip having a support bar attachment component 661, a chain 662, a clip attachment component 663, clip handles 664 and a clip body 665 are shown in FIG. 6. In the embodiment shown in FIG. 6, the clip body 665 grasps the flag spar 280 and squeezes the flag sleeve 292 tightly against the flag spar 280. Spring tension in the clip 660 secures the hold and ensures that the flag 190 can not slide up and down the flag spar 280 when under heavy wind conditions. A user can squeeze the clip handles 664 together and release the clip body 665 from the flag 190 and flag spar 280 in order to move, remove, or replace the flag 190.

Likewise, the flag spar 160 is depicted as being a cylindrical dowel, but can be shaped differently in other embodiments.

In one embodiment, the flag spar 280 comprises two or more sections that can be detached or separated from one another for ease of storage. Such sections can attach to one another via screw-type threads, shock-cords and male/female ends, telescoping and locking components, etc.

When fully assembled, the flag pole 120 is attached to the support bar 130. The attachment point is approximately the center of the support bar 130. In other embodiments, other attachment points can be utilized. In yet other embodiments, more than one flag pole 120 can be used to securely hold the support bar 130 in a given position.

In one embodiment, the flag pole 120 comprises two or more sections that can be detached or separated from one another for ease of storage. Such sections can attach to one another via screw-type threads, shock-cords and male/female ends, telescoping and locking components, etc.

Not shown in the FIGs. is an optional flag storage compartment that can be added to the apparatus to store and protect a flag 190 when it is not actively being displayed. In another embodiment, the flag spar 280 can be configured to rotate so that the flag 190 can be wound around the flag spar 280 and the storage compartment can be extended down from the support bar 130 to enclose the stored flag 190 and the flag spar 280. As an example, the rotating flag spar 280 can act in a manner similar to a window shade where the exposed end of a flag 190 is pulled to rotate the spar 280 and extend the flag 190 into displayed position. When the flag 190 is to be stored, a sharp downwards tug releases the roll-up mechanism allowing the spar 280 to rotate and roll-up the flag 190 into a stored position.

Also not shown in FIG. 1 is an optional flag retention piece. In one embodiment, the flag retention piece could be a high-friction material such as rubber or other non-slip material that is attached to the flag spar 280 in order to reduce the possibility of the flag sleeve 292 slipping on the flag spar 280.

It is contemplated that in some embodiments, the support bar 130 could be in close proximity to the spar 280 in order to securely hold the flag 190 between them.

The above specification, examples and data provide a description of the structure and use of exemplary embodiments of the described articles of manufacture and methods. It will further be understood from the foregoing description that various modifications and changes may be made in the embodiments of the present invention without departing from its true spirit. This description is intended for purposes of illustration only and should not be construed in a limiting sense. The scope of this invention should be limited only by the language of the following claims.

What is claimed is:

1. A vertical flag display apparatus, comprising:
a support bar having a first support end and a second support end;
a flag spar having a first spar end and a second spar end;
a flag pole having a distal end and a proximal end;
a first locking end cap and a second locking end cap; and
wherein the flag pole is attached near the center of the support bar, the first locking end cap is attached to the first support end and the second locking end cap is attached to the second support end, and the first locking end cap is attached to the first spar end and the second locking end cap is attached to the second spar end such that a flag can be hung from the flag spar between the first and second locking end caps.

2. The apparatus of claim 1 wherein the flag spar is configured to slide through a sleeve on a flag.

3. The apparatus of claim 1 wherein the flag spar is configured to securely receive and hold an edge of a flag.

4. The apparatus of claim 2 wherein the first and second locking end caps are configured to removably attach to either the first flag spar end or the second spar end such that when attached, the first and second locking end caps secure the flag onto the flag spar and hold the flag spar in a fixed orientation relative to the support bar.

5. The apparatus of claim 3 wherein the first and second locking end caps are configured to removably attach to either the first flag spar end or the second spar end such that when attached, the first and second locking end caps secure the flag onto the flag spar and hold the flag spar in a fixed orientation relative to the support bar.

6. The apparatus of claim 1 further comprising an attachment bracket configured to accept the proximal end of the flag pole and to hold the flag pole securely relative to an attachment point.

7. The apparatus of claim 2 further comprising an attachment bracket configured to accept the proximal end of the flag pole and to hold the flag pole securely relative to an attachment point.

8. The apparatus of claim 3 further comprising an attachment bracket configured to accept the proximal end of the flag pole and to hold the flag pole securely relative to an attachment point.

9. The apparatus of claim 4 further comprising an attachment bracket configured to accept the proximal end of the flag pole and to hold the flag pole securely relative to an attachment point.

10. The apparatus of claim 5 further comprising an attachment bracket configured to accept the proximal end of the flag pole and to hold the flag pole securely relative to an attachment point.

11. The apparatus of claim 1 further comprising a first accent cap and a second accent cap wherein the first accent cap secures the first spar end to the first locking end cap and the second accent cap secures the second spar end to the second locking end cap.

12. The apparatus of claim 2 further comprising a first accent cap and a second accent cap wherein the first accent cap secures the first spar end to the first locking end cap and the second accent cap secures the second spar end to the second locking end cap.

13. The apparatus of claim 6 further comprising a first accent cap and a second accent cap wherein the first accent cap secures the first spar end to the first locking end cap and the second accent cap secures the second spar end to the second locking end cap.

14. The apparatus of claim 7 further comprising a first accent cap and a second accent cap wherein the first accent cap secures the first spar end to the first locking end cap and the second accent cap secures the second spar end to the second locking end cap.

15. The apparatus of claim 5 further comprising a first accent cap and a second accent cap wherein the first accent cap secures the first spar end to the first locking end cap and the second accent cap secures the second spar end to the second locking end cap.

16. The apparatus of claim 1 further comprising a first locking clip and a second locking clip wherein the first locking clip is configured to secure a first flag end to the first spar end and the second locking clip is configured to secure a second flag end to the second spar end.

17. The apparatus of claim 2 further comprising a first locking clip and a second locking clip wherein the first locking clip is configured to secure a first flag end to the first spar end and the second locking clip is configured to secure a second flag end to the second spar end.

18. The apparatus of claim 6 further comprising a first locking clip and a second locking clip wherein the first locking clip is configured to secure a first flag end to the first spar end and the second locking clip is configured to secure a second flag end to the second spar end.

19. The apparatus of claim 11 further comprising a first locking clip and a second locking clip wherein the first locking clip is configured to secure a first flag end to the first spar end and the second locking clip is configured to secure a second flag end to the second spar end.

20. The apparatus of claim 15 further comprising a first locking clip and a second locking clip wherein the first locking clip is configured to secure a first flag end to the first spar end and the second locking clip is configured to secure a second flag end to the second spar end.
